(19) United States
(12) Patent Application Publication
(10) Pub. No.: US 2010/0190376 A1
(43) Pub. Date: Jul. 29, 2010

(54) Receptacle of RF microwave connector for telecommunication

(76) Inventors: Sung-Wen Chen, Hsin-Tien City (TW); Tung-Liang Huang, Hsin-Tien City (TW)

Correspondence Address: G. LINK CO., LTD., 3550 BELL ROAD, MINOOKA, IL, 60447, US

(21) Appl. No.: 11/978,557

(22) Filed: Oct. 30, 2007

(30) Foreign Application Priority Data
Jul. 9, 2007 (TW) 096215034

(51) Int. Cl. H01R 9/05

(52) U.S. Cl. 439/578

(57) ABSTRACT

A receptacle of a RF microwave connecter for telecommunication comprises a metal housing with a upper end thereof disposed with a cylindrical main body used for engaging with a periphery of a metal housing of a receptacle with a male terminal and an insulator with a center thereof formed with a projection part. A hollow portion is disposed on the projection part and used for engaging with a female terminal to allow a plug with a female terminal also to be coupled onto a circuit board to use as a receptacle so as to have a broader use.

### BACKGROUND OF THE INVENTION

1. Field of the Invention

The present invention relates to an electric connecter, and more particularly to a receptacle of a RF (radio frequency) microwave for telecommunication.

2. Description of Related Art

U.S. Pat. No. 7,217,156 entitled as “RF Microwave Connecter For Telecommunication” discloses a connecter comprising a plug and a receptacle, in which the plug is provided with a metal housing coupled to an insulator; a hollow portion of the insulator is coupled to a female terminal; the female terminal is provided with a main body; two opposite contact sheets used for clamping a male terminal; two opposite contace sheets are respectively extended from two sides of one end of the main body; another end of the main body is provided with a curved clamping section; two sides of the clamping section are symmetrically curvedly bended to allow the two sides of the clamping section be bended oppositely and smoothly to clamp an inner wire of a coaxial cable stably during an operation of coupling the clamping section to the inner wire. Please refer to FIGS. 5A and 5B, a receptacle 10 is provided with a metal housing 11, and a plurality of tabs 111, 112 and 113 are extended outward from a lower end of the metal housing 11; grooves 121, 122, 123 of an insulator 12 are respectively coupled to the tabs 111, 112 and 113 and the tabs 111, 112 and 113 are also extended to the outside of the insulator 12; a projection part 124 is formed at a center of the insulator 12 and extended into an inner part of the metal housing 11; a hollow portion 125 of the projection part 124 is coupled to a male terminal 13 and a contact sheet 131 bended toward one side of the male terminal 13 is disposed on a lower end thereof; a groove 126 of a bottom of the insulator 12 is coupled to the contact sheet 131 and the contact sheet 131 is extended to the outside of the insulator 12.

A plug of a general connecter is provided with a female terminal and coupled to a coaxial cable, and a receptacle is provided with a male terminal used for coupling onto a circuit disclosed by patents such as U.S. Pat. No. 5,772,470 and U.S. Pat. No. 7,217,153 mentioned above.

### SUMMARY OF THE INVENTION

For allowing a plug with a female terminal also to couple onto a circuit board to take as a receptacle to enable the plug with a female terminal to have a broader use, the present invention is proposed.

The main object of the present invention is to provide a receptacle of a RF microwave connecter for telecommunication, allowing a receptacle with a female terminal to be coupled onto a circuit board to enable the use of the conventional plug with a female terminal to be broader.

Another object of the present invention is to provide a receptacle of a RF microwave connecter for telecommunication, allowing a plurality of receptacles with a female terminal coupled onto a circuit board to be respectively and simultaneously plugged in a plurality of receptacles with a male terminal on another circuit board to enable a plugging operation between a plurality of male and female terminals to be more convenient.

### BRIEF DESCRIPTION OF THE DRAWINGS

The present invention can be more fully understood by reference to the following description and accompanying drawings, in which:

FIG. 1A is a perspective view, showing a female and an insulator of a receptacle in a separation state of a first preferred embodiment according to the present invention;

FIG. 1B is a perspective view, showing a bottom of the receptacle facing upward of the first embodiment according to the present invention;

FIG. 1C is a perspective view of the receptacle of the first embodiment according to the present invention;

FIG. 2A is a perspective view, showing a female and an insulator of a receptacle in a separation state of a second preferred embodiment according to the present invention;

FIG. 2B is a perspective view, showing a bottom of the receptacle facing upward of the second embodiment according to the present invention;

FIG. 2C is a perspective view of the receptacle of the second embodiment according to the present invention;

FIG. 3A is a perspective view, showing a female and an insulator of a receptacle in a separation state of a third preferred embodiment according to the present invention;

FIG. 3B is a perspective view, showing a bottom of the receptacle facing upward of the third embodiment according to the present invention;

FIG. 3C is a perspective view of the receptacle of the third embodiment according to the present invention;

FIG. 4A is a perspective view, showing a female and an insulator of a receptacle in a separation state of a fourth preferred embodiment according to the present invention;

FIG. 4B is a perspective view, showing a bottom of the receptacle facing upward of the fourth embodiment according to the present invention;

FIG. 4C is a perspective view of the receptacle of the fourth embodiment according to the present invention;

FIG. 5A is a perspective view of a bottom of a conventional receptacle with a male terminal facing upward;

FIG. 5B is a perspective view of the conventional receptacle with a male terminal;

FIG. 6A is a first cross sectional view, showing the receptacle of the first embodiment according to the present invention and a receptacle with a male terminal in a separation state;

FIG. 6B is a first cross sectional view, showing the receptacle of the first embodiment according to the present invention and a receptacle with a male terminal in a coupling state;

FIG. 7A is a second cross sectional view, showing the receptacle of the first embodiment according to the present invention and a receptacle with a male terminal in a separation state; and

FIG. 7B is a second cross sectional view, showing the receptacle of the first embodiment according to the present invention and a receptacle with a male terminal in a coupling state.

### DETAILED DESCRIPTION OF THE PREFERRED EMBODIMENTS

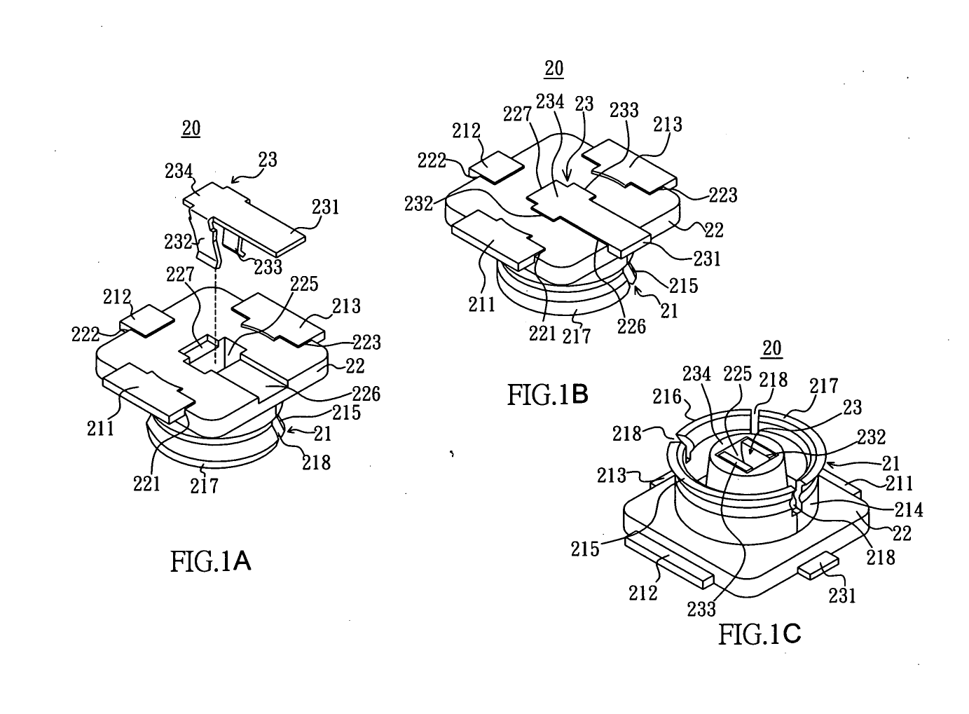

Please refer to FIGS. 1A, 1B and 10. A receptacle of a RF microwave connecter for telecommunication is used for allowing a receptacle with a female terminal to be coupled onto a circuit board and used for plugging in a receptacle with a male terminal. A receptacle 20 of a first preferred embodiment according to the present invention comprises a metal housing 21, an insulator 22 and a female terminal 23.

A plurality of tabs 211, 212 and 213 are extended outward from a lower end of the metal housing 21; a cylindrical main body 214 is disposed at a upper end of the housing 21 and a plurality of coupling sheets 215, 216 and 217 are disposed on a upper end of the cylindrical main body 214; a gap 218 is disposed between each two adjacent sides of the plurality of buckling sheets 215, 216 and 217; upper ends of the plurality of buckling sheets 215, 216 and 217 are respectively expanded from the outside of the cylindrical main body 214 to cause the upper end of the cylindrical main body 214 to be provided with a larger diameter than a lower end thereof so as to allow the cylindrical main body 214 to be engaged with a periphery of a metal housing of a receptacle with a male terminal. The cylindrical main body 214 is provided with three sheets of buckling sheets 215, 216 and 217 in this embodiment.

Grooves 221, 222 and 223 are disposed on a lower end of the insulator 22; the grooves 221, 222 and 223 are respectively coupled to the corresponding tabs 211, 212 and 213; a projection part 224 is formed at a center part of the insulator 22 and extended in the metal housing 21; the projection part 224 is disposed with a hollow portion 225 with a rectangular cross section; two grooves 226 and 227 communicated with the hollow portion 225 are further disposed on a bottom of the insulator 22.

The female terminal 23 comprises a sheet body 231 and two contact sheets 232, 233; the two contact sheets 232, 233 are accepted in the hollow portion 225 of the insulator 22 and used for engaging with an outer side of a male terminal of the receptacle with a male terminal; the grooves 223, 227 of the insulator 22 are respectively coupled to the sheet body 231 and a front section 234 thereof and the sheet body 231 is extended to the outside of the insulator 22.

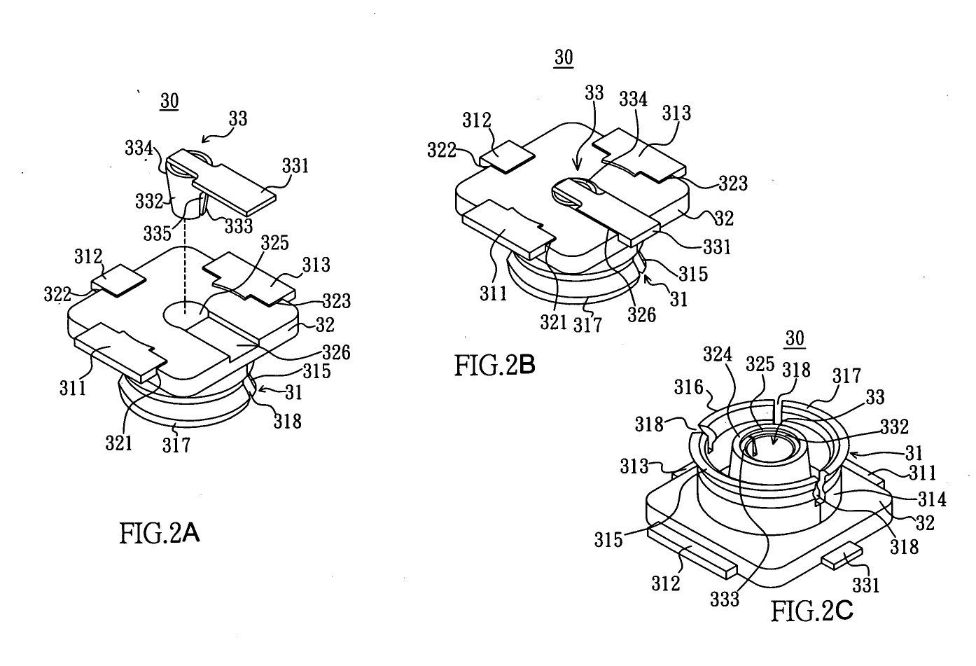

Please refer to FIGS. 1C, 2A, 2B and 2C. A receptacle 30 of a second preferred embodiment according to the present invention comprises a metal housing 31, an insulator 32 and a female terminal 33.

The metal housing 31 similar to the metal housing 21 of the first embodiment is disposed with a plurality of tabs 311, 312, 313 and a cylindrical main body 314; a plurality of buckling sheets 315, 316, 317 and a plurality of gaps 318 are disposed on a upper end of the cylindrical main body 314.

The insulator 32 similar to the insulator 22 of the first embodiment is disposed with a plurality of grooves 321, 322, 323, 326 and a projection part 324. But, the projection part 324 is provided with a hollow portion 325 with a circular cross section. A coupling way of the metal housing 31 and the insulator 32 is the same as the coupling way of the metal housing 21 and the insulator 22 of the first embodiment.

The female terminal 33 comprises a sheet body 331 and two contact sheets 332, 333; the two contact sheets 332, 333 are first bended upward by means of a front section 334 of the sheet body 331, and two sides of the front section 334 are then allowed to bend to form a cylinder-like body in a direction being near to the sheet body 331; a gap 335 is disposed between each two adjacent sides of the two contact sheets 332, 333 to separate the two contact sheets 332, 333 from each other; the two contact sheets 332, 333 are accepted in the hollow portion 325 of the insulator 32 and used for engaging with an outer side of a male terminal of a receptacle with a male terminal; the groove 326 of the insulator 32 is coupled to the sheet body 331 and the sheet body is extended to the outside of the insulator 32.

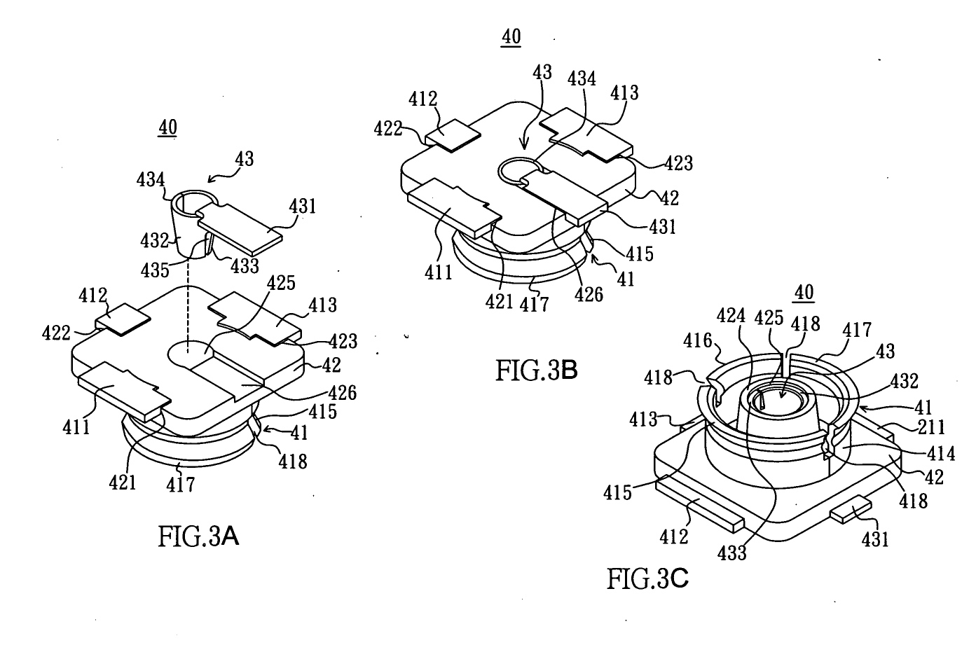

Please refer to FIGS. 1C, 3A, 3B and 3C. A receptacle 40 of a third preferred embodiment according to the present invention comprises a metal housing 41, an insulator 42 and a female terminal 43.

A metal housing 41 similar to the metal housing 21 of the first embodiment is disposed with a plurality of tabs 411, 412, 413 and a cylindrical main body 414; a plurality of buckling sheets 415, 416, 417 and a plurality of gaps 418 are disposed on a upper end of the cylindrical main body 414.

The insulator 42 similar to the insulator 22 of the first embodiment is disposed with a plurality of grooves 421, 422, 423, 426 and a projection part 424. But, a hollow portion 425 with a circular cross section is disposed on the projection part 424. A coupling way of the metal housing and the insulator 42 is the same as the coupling way of the metal housing 21 and the insulator 22.

The female terminal 43 comprises a sheet body 431 and two contact sheets 432, 433; the two contact sheets 432, 433 are first bended upward by means of a front section 434 of the sheet body 431, and two sides of the front section 434 is then allowed to bend to form a cylinder-like body in a direction being far away from the sheet body 431; a gap 435 is disposed between each two adjacent sides of the two contact sheets 432, 433 to separate the two contact sheets 432, 433 from each other; the two contact sheets 432, 433 are accepted in the hollow portion 425 of the insulator 42 and used for engaging with an outer side of a male terminal of an receptacle with a male terminal; the groove 426 of the insulator 42 is coupled to the sheet body 431 and extended to the outside of the insulator 42.

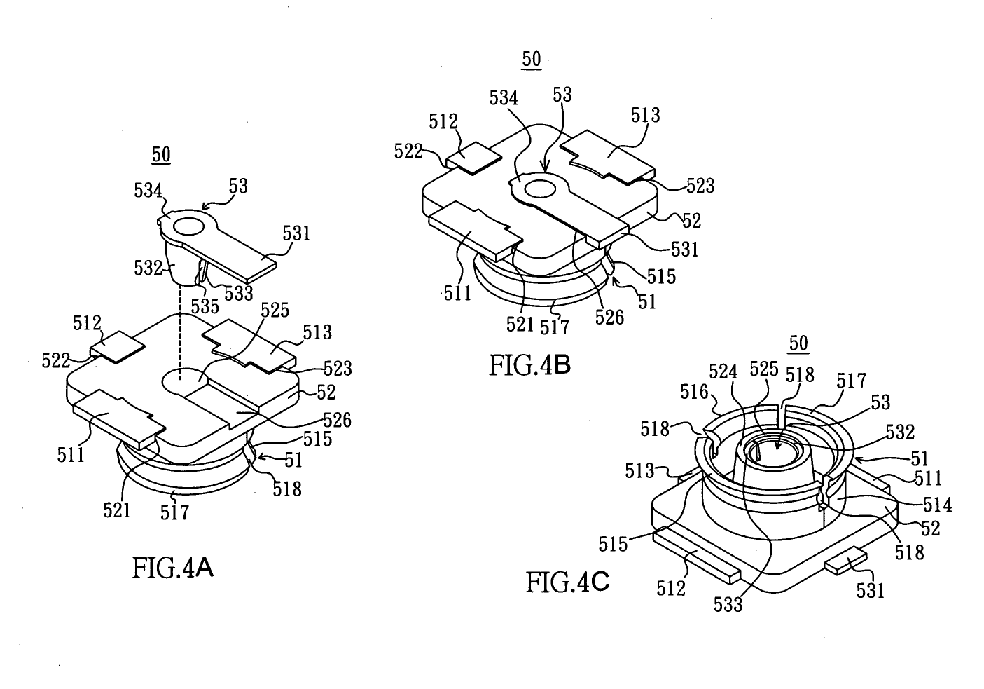

Please refer to FIGS. 10, 4A, 4B and 4C. A receptacle 50 of a fourth preferred embodiment of the present invention comprises a metal housing 51, an insulator 52 and a female terminal 53.

The metal housing 51 similar to the metal housing 21 of the first embodiment is disposed with a plurality of tabs 511, 512, 513 and a cylindrical main body 514; a plurality of buckling sheets 515, 516, 517 and a plurality of gaps 518 are disposed on a upper end of the cylindrical main body 514.

The insulator 52 similar to the insulator 22 of the first embodiment is disposed with a plurality of grooves 521, 522, 523, 526 and a projection part 524. But, a hollow portion 525 with a circular cross section is disposed on the projection part 524. A coupling way of the metal housing and the insulator 52 is the same as the coupling way of the metal housing 21 and the insulator 22.

The female terminal 53 comprises a sheet body 531 and two contact sheets 532, 533; the two contact sheets 532, 533 are formed by drawing a front section 534 of the sheet body upward; a gap 535 is disposed between each two adjacent sides of the two contact sheets 532, 533 to separate the two contact sheets 532, 533 from each other; the two contact sheets 532, 533 are accepted in the hollow portion 525 of the insulator 52 and used for engaging with an outer side of a male terminal of an receptacle with a male terminal; the groove 526 of the insulator 52 is coupled to the sheet body 531 and extended to the outside of the insulator 52.

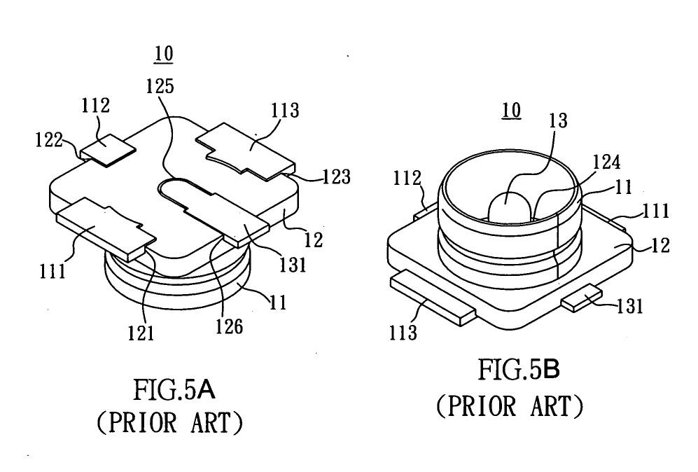

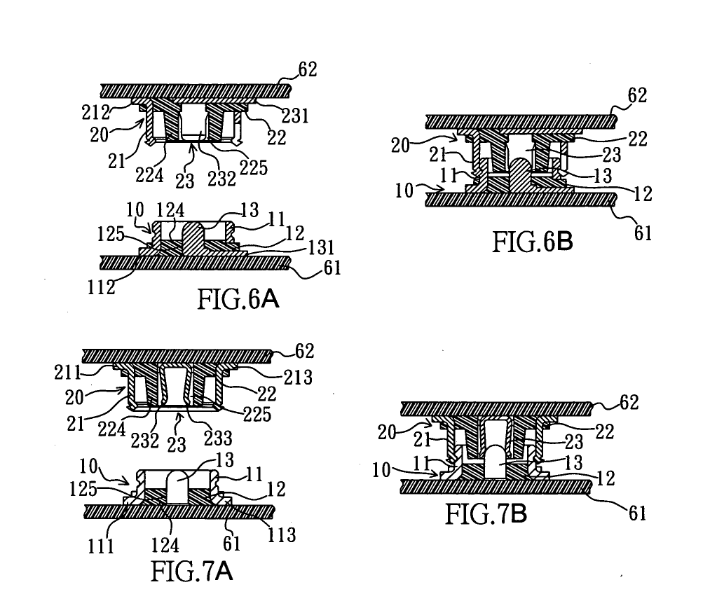

Please refer to FIGS. 1C, 5B, 6A, 6B, 7A and 7B. The conventional receptacle 10 with the male terminal 13 is used for coupling onto the circuit board 61. Besides, a bottom of the receptacle 20 of the present invention may also be coupled onto a circuit board 62, and the tabs 211, 212, 213 of the metal housing 21 and the sheet body 231 of the female terminal 23 may also be electrically connected to wires on the circuit board 62 to allow the receptacle 20 with the female terminal 23 to be coupled onto the circuit board 62 as FIGS. 6A(and 7A show and not to be coupled to a general coaxial cable.

The two contact sheets 232, 233 of the female terminal 23 of the present invention may be engaged with an outer side of the male terminal 13, and the metal housing 21 is provided with a plurality of buckling sheets capable of being engaged with a periphery of the metal housing 11 of the conventional receptacle 20 to allow the receptacle 20 of the present invention to be coupled to the conventional receptacle 10 as FIGS. 6B and 7B show. When the circuit board 61 is coupled to the plurality of the conventional receptacles 10 with the male terminal 13 and the circuit board 62 is coupled to the plurality of the receptacles 20 with the female terminal 23, the plurality of conventional receptacles 10 can be allowed to respectively couple to the plurality of receptacles 20 simultaneously by approaching the two circuit boards 61, 62 to each other.

According to the present invention, a plug with a female terminal may also be allowed to couple onto the circuit board to be used as a receptacle so as to have a broader use and allow a plurality of receptacles with a female terminal coupled onto a circuit board and a plurality of receptacles with a male terminal on another circuit to be plugged to each other to be convenient for a plugging operation among the plurality of male and female terminals.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A receptacle of a RF microwave connecter for telecommunication, used for coupling onto a circuit board and plugging in a receptacle with a male terminal, and comprising:
a metal housing, a upper end thereof being disposed with a cylindrical main body; a diameter of a upper end of said cylindrical main body being larger than a lower end thereof and said cylindrical main body being used for engaging with a periphery of said receptacle with a male terminal;
an insulator, a projection part being formed on a center thereof; said projection part being extended in an inner part of said metal housing; said projection part being disposed with a hollow portion;
a female terminal, comprising a sheet body and two contact sheets; said two contact sheets being accepted in said hollow portion and used for engaging with an outer side of a male terminal of said receptacle with a male terminal;
said sheet body being extended to the outside of said insulator.

2. The receptacle of a RF microwave connecter for telecommunication according to claim 1, wherein a plurality of buckling sheets are disposed on said upper end of said cylindrical main body; a gap is disposed between each two adjacent sides of said buckling sheets;
upper ends of said buckling sheets are respectively expanded outward from said cylindrical main body.

3. The receptacle of a RF microwave connecter for telecommunication according to claim 2, wherein a groove communicated with said hollow portion is disposed on a bottom of said insulator, said groove is coupled to said sheet body.

4. The receptacle of a RF microwave connecter for telecommunication according to claim 3, wherein a plurality of tabs extended outward are disposed on a lower end of said metal housing; a bottom of said insulator is provided with a plurality of grooves corresponding to said plurality of tabs to respectively couple to said plurality of tabs; said plurality of tabs are respectively extended to the outside of said insulator.

5. The receptacle of a RF microwave connecter for telecommunication according to claim 4, wherein three buckling sheets are disposed on said upper end of said cylindrical main body.

6. The receptacle of a RF microwave connecter for telecommunication according to claim 5, wherein a cross section of said hollow portion is rectangular, said two contact sheets are formed by respectively bending upward from two sides of said sheet body.

7. The receptacle of a RF microwave connecter for telecommunication according to claim 6, wherein said sheet body is provided with a front section; a groove corresponding to said front section is disposed on said bottom of said insulator to couple to said front section.

8. The receptacle of a RF microwave connecter for telecommunication according to claim 2, wherein a cross section of said hollow portion is rectangular, said two contact sheets are formed by respectively bending upward from two sides of said sheet body.

9. The receptacle of a RF microwave connecter for telecommunication according to claim 8, wherein said sheet-body is provided with a front section; a groove corresponding to said front section is disposed on said bottom of said insulator to couple to said front section.

10. The receptacle of a RF microwave connecter for telecommunication according to claim 3, wherein a cross section of said hollow portion is rectangular, said two contact sheets are formed by respectively bending upward from two sides of said sheet body.

11. The receptacle of a RF microwave connecter for telecommunication according to claim 10, wherein said sheet body is provided with a front section; a groove corresponding to said front section is disposed on said bottom of said insulator to couple to said front section.

12. The receptacle of a RF microwave connecter for telecommunication according to claim 4, wherein a cross section of said hollow portion is rectangular, said two contact sheets are formed by respectively bending upward from two sides of said sheet body.

13. The receptacle of a RF microwave connecter for telecommunication according to claim 12, wherein said sheet body is provided with a front section; a groove corresponding to said front section is disposed on said bottom of said insulator to couple to said front section.

14. The receptacle of a RF microwave connecter for telecommunication according to claim 5, wherein a cross section of said hollow portion is rectangular, said two contact sheets are formed by respectively bending upward from two sides of said sheet body.

15. The receptacle of a RF microwave connecter for telecommunication according to claim 14, wherein said sheet body is provided with a front section; a groove corresponding to said front section is disposed on said bottom of said insulator to couple to said front section.

16. The receptacle of a RF microwave connecter for telecommunication according to claim 5, wherein a cross section of said hollow portion is circular; said sheet body is provided with a front section; said two contact sheets are formed by bending said front section upward and bending two sides of said front section oppositely to from a cylinder-like body in a direction being near to said sheet body; a gap is disposed between each two adjacent sides of said two contact sheets to separate said two contact sheets from each other.

17. The receptacle of a RF microwave connecter for telecommunication according to claim 5, wherein a cross section of said hollow portion is circular; said sheet body is provided with a front section; said two contact sheets are formed by bending said front section upward and bending two sides of said front section oppositely to from a cylinder-like body in a direction being far away from said sheet body; a gap is disposed between each two adjacent sides of said two contact sheets to separate said two contact sheets from each other.

18. The receptacle of a RF microwave connecter for telecommunication according to claim 5, wherein a cross section of said hollow portion is circular; said sheet body is provided with a front section; said two contact sheets are formed by drawing said front section upward;
a gap is disposed between each two adjacent sides of said two contact sheets to separate said two contact sheets from each other.
